(19) United States
(12) Patent Application Publication
(10) Pub. No.: US 2012/0259575 A1
(43) Pub. Date: Oct. 11, 2012

(54) INTEGRATED CIRCUIT CHIP INCORPORATING A TEST CIRCUIT THAT ALLOWS FOR ON-CHIP STRESS TESTING IN ORDER TO MODEL OR MONITOR DEVICE PERFORMANCE DEGRADATION

(75) Inventors: Carole D. Graas, Jericho, VT (US); Deborah M. Massey, Jericho, VT (US); John Greg Massey, Jericho, VT (US); Pascal A. Nsame, Essex Junction, VT (US)

(73) Assignee: International Business Machines Corporation, Armonk, NY (US)

(21) Appl. No.: 13/082,066

(22) Filed: Apr. 7, 2011

(51) Int. Cl. G06F 19/00

(52) U.S. Cl. 702/120

(57) ABSTRACT

Disclosed is an integrated circuit chip incorporating a test circuit having multiple logic blocks. Each logic block is a matrix of individually selectable, physically different, test devices in a specific class of devices. An embedded processor ensures that specific stress conditions are selectively applied to the test devices and further controls selective testing, by a sensor system, of the test devices to determine the impact of the applied stress conditions. In a laboratory or test system environment, accelerated stress conditions are selectively applied to the test devices and the testing results are used to model device performance degradation due to class-specific failure mechanisms. In the field, stress conditions are selectively applied to test devices so as to mimic stress conditions impacting active devices in use on the same chip and the testing results are used to indirectly monitor performance degradation of the active devices due to class-specific failure mechanisms.

### BACKGROUND

1. Field of the Invention

The disclosed embodiments relate to modeling and monitoring device performance degradation due to various failure mechanisms and, more particularly, to an integrated circuit chip incorporating a test circuit that allows for on-chip stress testing to either model device performance degradation or to monitor (i.e., track) device performance degradation.

2. Description of the Related Art

Various mechanisms associated with different classes of devices (e.g., gate oxide integrity (GOI), negative bias temperature instability (NBTI), positive bias temperature instability (PBTI), and hot carrier injection (HCI) associated with metal oxide semiconductor field effect transistors (MOSFETS); reverse bias secondary breakdown (RBSB) associated with bipolar junction transistors (BJTs); etc.) can cause the performance of such devices to degrade over time. Typically, in order to predict how an integrated circuit chip will perform over time, all devices available in a given semiconductor technology node associated with the chip or at least all devices contained in the design chip are subjected to accelerated voltage and/or temperature stress tests in a laboratory environment and/or in a test system environment. Then, based on the results of the accelerated stress testing, performance degradation models and useful life predictions for the devices individually and for the chip as a whole are generated. Unfortunately, existing techniques for generating performance degradation models and useful life predictions require multiple experiments on a statistical sample of hardware and, thus, can be costly and time-consuming. Furthermore, techniques are currently not available for monitoring (i.e., tracking) device performance in the field (i.e., for monitoring the performance of devices on an integrated circuit chip incorporated into a product) in order to allow the performance degradation models to be updated in real-time. Therefore, there is a need in the art for an on-chip test circuit that can be used to stress test devices in a laboratory or test system environment in order to model performance degradation as a function of various class-specific failure mechanisms and that can also be used to stress test devices in the field in order to monitor (i.e., track) device performance degradation as a function of the same failure mechanisms.

### SUMMARY

In view of the foregoing, disclosed herein are embodiments of an integrated circuit chip that incorporates a test circuit having multiple logic blocks. Each logic block is a matrix of individually selectable, physically different, test devices in a specific class of devices. An embedded processor is operatively connected to the logic blocks, a sensor system, and temperature and voltage regulation systems for the chip. The embedded processor ensures that specific stress conditions are selectively applied, by the temperature and voltage regulation systems, to the test devices and further controls selective testing, by the sensor system, of the test devices to determine the impact of the applied stress conditions. In a laboratory or test system environment, accelerated stress conditions are selectively applied to the test devices and the testing results are used to model device performance degradation due to class-specific failure mechanisms. In the field (i.e., when incorporated into a product), stress conditions are selectively applied to the test devices so as to mimic the stress conditions impacting active devices in use on the same chip and the testing results are used to indirectly monitor (i.e., indirectly track) performance degradation of the active devices due to class-specific failure mechanisms.

More particularly, one embodiment of an integrated circuit chip circuit can comprise a test circuit for use in a laboratory environment. This test circuit can comprise multiple logic blocks (i.e., logic clouds). Each one of the multiple logic blocks can be associated with a specific class of devices and can comprise a matrix of individually selectable, physically different, test devices in the specific class. In this case, the test devices can comprise, for example, duplicates of the devices contained in a given functional circuit design or duplicates of devices in a given semiconductor technology node. The test circuit can further comprise a sensor system and an embedded processor operatively connected to the multiple logic blocks and the sensor system. The embedded processor can control selective stressing (e.g., accelerated stressing) of the test devices. Specifically, the embedded processor can cause a specific test device in the matrix of a specific logic block to be subjected to specific stress conditions (e.g., a specific voltage as applied by a discrete voltage regulator and/or a specific temperature as applied by a heat source, such as an oven). The embedded processor can also control selective testing of the test devices to determine the impact of the applied stress conditions. Specifically, the embedded processor can cause the sensor system to determine an actual value of a specific electrical characteristic exhibited by the specific test device following application of the specific stress conditions. Testing results can then be used to model device performance degradation due to various class-specific failure mechanisms.

Another embodiment of an integrated circuit chip can be incorporated into a test system and can comprise at least one functional circuit as well as a test circuit. The functional circuit(s) can comprise a plurality of active devices. As in the previously described embodiment, the test circuit can comprise multiple logic blocks (i.e., logic clouds). Each one of the multiple logic blocks can be associated with a specific class of devices and can comprise a matrix of individually selectable, physically different, test devices in the specific class. However, in this case, the test devices can comprise duplicates of the active devices contained in the functional circuit(s). The test circuit can further comprise a sensor system and an embedded processor operatively connected to the multiple logic blocks and the sensor system. The embedded processor can control selective stressing (e.g., accelerated stressing) of the test devices. Specifically, the embedded processor can cause a specific test device in the matrix of a specific logic block to be subjected to specific stress conditions (e.g., a specific voltage as applied by the voltage regulation system of the test system and/or a specific temperature as achieved by regulating processing in the test system). The embedded processor can also control selective testing of the test devices to determine the impact of the applied stress conditions. Specifically, the embedded processor can cause the sensor system to determine an actual value of a specific electrical characteristic exhibited by the specific test device following application of the specific stress conditions. Testing results can then be used to model device performance degradation due to various class-specific failure mechanisms. It should be noted that this embodiment is only made practicable if the embedded processor is remote access service (RAS) enabled so as to allow for remote communication with embedded processor (e.g., to update embedded processor programming for selective stressing and/testing, to initiate selective stressing and/or testing on demand, to receive testing results, etc.).

Yet another embodiment of an integrated circuit chip can be incorporated into a product in use and can comprise at least one functional circuit as well as a test circuit. The functional circuit(s) can comprise a plurality of active devices in use in the product. As in the previously described embodiments, the test circuit can comprise multiple logic blocks (i.e., logic clouds). Each one of the multiple logic blocks can be associated with a specific class of devices and can comprise a matrix of individually selectable, physically different, test devices in the specific class. In this case, the test devices can comprise duplicates of the active devices contained in the functional circuit(s). The test circuit can further comprise a sensor system and an embedded processor operatively connected to the multiple logic blocks and the sensor system. The embedded processor can control selective stressing of the test devices. Specifically, the embedded processor can cause a specific test device in the matrix of a specific logic block to be subjected to specific stress conditions (e.g., a specific voltage as applied by the voltage regulation system of the product and/or a specific temperature as achieved by regulating processing by the product). However, in this case, the specific stress conditions to which the test device is subjected will approximate the in-use stress conditions imparted on a corresponding active device (i.e., an active device for which the test device is a duplicate). The embedded processor can also control selective testing of the test devices to determine the impact of the applied stress conditions. Specifically, the embedded processor can cause the sensor system to determine an actual value of a specific electrical characteristic exhibited by the specific test device following application of the specific stress conditions. Since the test devices and active device are subjected to essentially the same stress conditions, the testing results for the test devices can be used to indirectly monitor performance degradation of the active devices due to various class-specific failure mechanisms. It should be noted that this embodiment is also only made practicable if the embedded processor is remote access service (RAS) enabled so as to allow for remote communication with embedded processor (e.g., to update embedded processor programming for selective stressing and testing, to initiate selective stressing and/or testing on demand, to receive testing results, etc.).

### BRIEF DESCRIPTION OF THE SEVERAL VIEWS OF THE DRAWINGS

The embodiments disclosed herein will be better understood from the following detailed description with reference to the drawings, which are not necessarily drawn to scale and in which:

FIG. 1 is a schematic diagram illustrating an embodiment of an integrated circuit chip having a test circuit that allows for on-chip stress testing in order to model or monitor device performance degradation;

FIG. 2 is a schematic diagram illustrating an exemplary logic block that can be incorporated into the integrated circuit chip of FIG. 1;

FIG. 3 is a schematic diagram illustrating an exemplary device that is configured for selective stressing and testing and that can be incorporated into the logic block of FIG. 2;

FIG. 4 is a schematic diagram illustrating the integrated circuit chip of FIG. 1 configured for use in a laboratory environment;

FIG. 5 is a schematic diagram illustrating the integrated circuit chip of FIG. 1 configured for use in a test system environment; and

FIG. 6 is a schematic diagram illustrating the integrated circuit chip of FIG. 1 configured for use in the field.

### DETAILED DESCRIPTION

The disclosed embodiments and the various features and advantageous details thereof are explained more fully with reference to the non-limiting embodiments that are illustrated in the accompanying drawings and detailed in the following description.

As mentioned above, various mechanisms associated with different classes of devices can cause the performance of such devices to degrade over time. Typically, in order to predict how an integrated circuit chip will perform over time, all devices available in a given semiconductor technology node associated with the chip or at least all devices contained in the design of the chip are subjected to accelerated voltage and/or temperature stress tests in a laboratory environment and/or in a test system environment. Then, based on the results of the accelerated stress testing, performance degradation models and useful life predictions for the devices individually and for the chip as a whole are generated. Unfortunately, existing techniques for generating performance degradation models and useful life predictions require multiple experiments on a statistical sample of hardware and, thus, can be costly and time-consuming. Furthermore, techniques are currently not available for monitoring (i.e., tracking) device performance in the field (i.e., for monitoring the performance of devices on an integrated circuit chip incorporated into a product) in order to allow the performance degradation models to be updated in real-time.

In view of the foregoing, disclosed herein are embodiments of an integrated circuit chip that incorporates a test circuit having multiple logic blocks (i.e., logic clouds). Each logic block is a matrix of individually selectable, physically different, test devices in a specific class of devices. An embedded processor is operatively connected to the logic blocks, a sensor system, and temperature and voltage regulation systems for the chip. The embedded processor ensures that specific stress conditions are selectively applied, by the temperature and voltage regulation systems, to the test devices and further controls selective testing, by the sensor system, of the test devices to determine the impact of the applied stress conditions. In a laboratory or test system environment, accelerated stress conditions are selectively applied to the test devices and the testing results are used to model device performance degradation due to class-specific failure mechanisms. In the field (i.e., when incorporated into a product), stress conditions are selectively applied to the test devices so as to mimic the stress conditions impacting active devices in use on the same chip and the testing results are used to indirectly monitor (i.e., indirectly track) performance degradation of the active devices due to class-specific failure mechanisms.

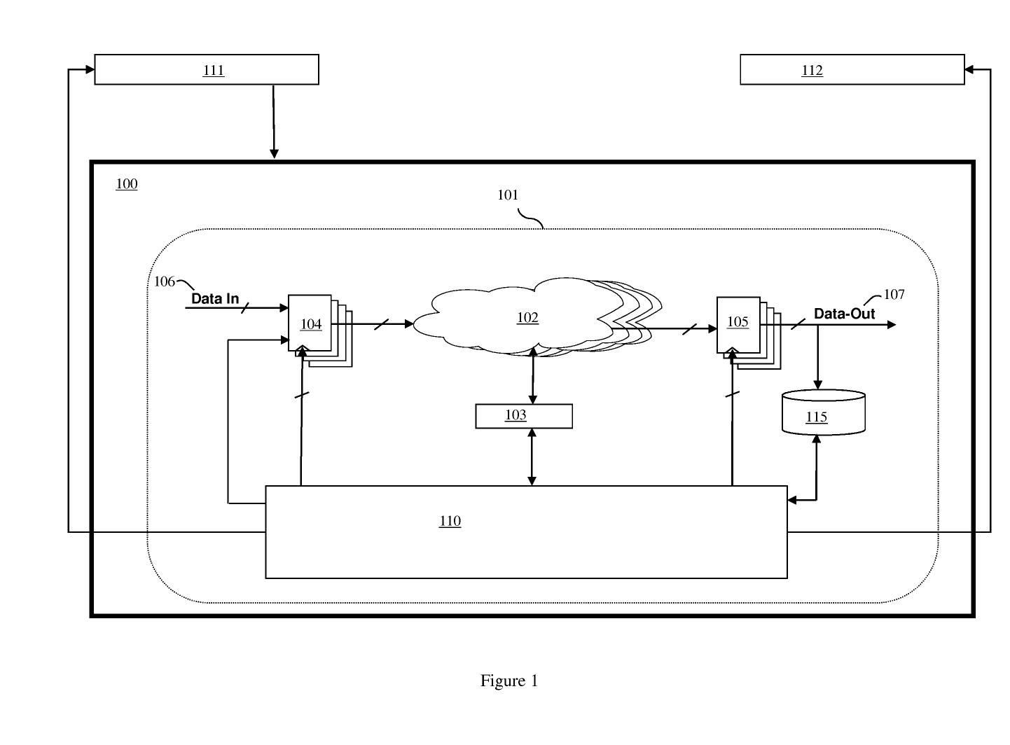

More particularly, referring to FIG. 1, disclosed herein are embodiments of an integrated circuit chip 100 that incorporates a test circuit 101. The test circuit 101 can comprise multiple logic blocks 102 (i.e., logic clouds).

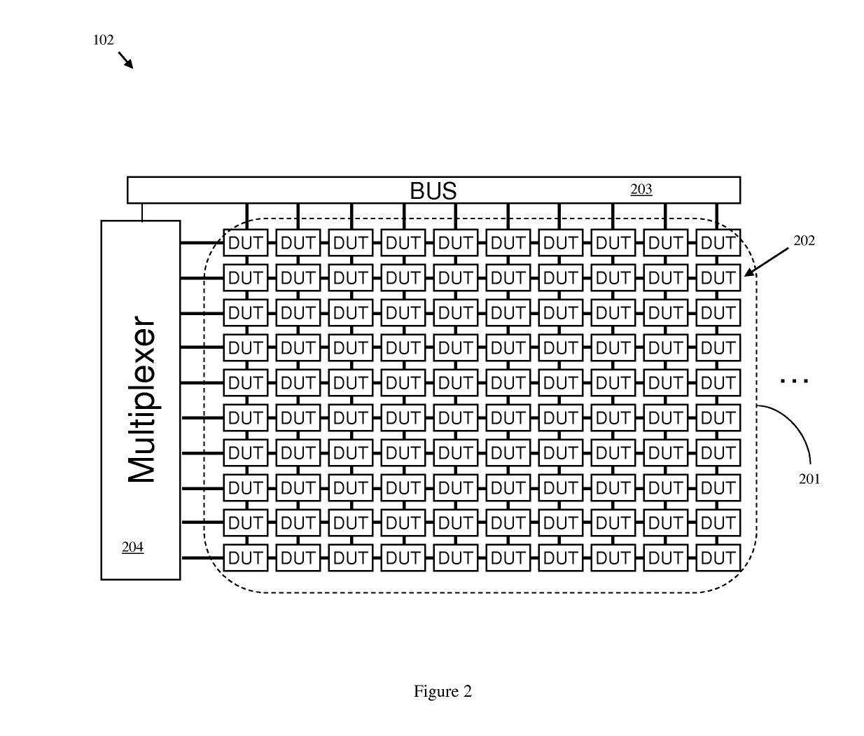

Referring to FIG. 2, each logic block 102 can be associated with a specific class of devices (i.e., a specific family of devices) and can comprise a matrix 201 of individually selectable, physically different, test devices 202 (i.e., devices under test (DUT)) in that specific class. That is, the test devices 202 in a matrix 201 of a given logic block 102 can comprise all metal oxide semiconductor field effect transistors (MOSFETs), all junction field effect transistors (JFETs), all bipolar junction transistors (BJTs), all heterojunction bipolar transistors (HBJTs), etc. While all of the test devices 202 in a given matrix 201 of a given logic block 102 are from the same class of devices, each test device in a given matrix 201 can be physically different from any other test device in the same matrix in at least one respect.

Specifically, the physical difference between each test device 202 in a given matrix 201 can be, for example, a difference in the dimension (i.e., height, thickness, etc.) of a component of the test device, a difference in the geometry (i.e., shape) of a component of the test device, a difference in a material used in a component of the test device, a difference in a dopant or dopant concentration used in a component of the test device, etc. As a result, the test devices 202 in a given matrix 201 can exhibit different electrical characteristics (e.g., different voltage values, current values, resistance values, etc) and may further be subject to different performance degradation rates as a function of different failure mechanisms. For example, in a given matrix 201 comprising all MOSFET-class test devices 202, each MOSFET-class test device can have a different channel length, a different channel width, a different gate dielectric thickness, a different gate dielectric material, and/or a different gate conductor material than other MOSFET-class test devices in the same matrix. Furthermore, as a result of these physical difference(s), the MOSFET-class test devices in the same matrix may exhibit different electrical characteristics (e.g., different threshold voltages (Vts), different drain currents (Id), etc.) and may further be subject to different performance degradation rates as a function of different failure mechanisms (e.g., as a function of gate oxide integrity (GOI), negative bias temperature instability (NBTI), positive bias temperature instability (PBTI), or hot carrier injection (HCI).)

Finally, each of the test devices 202 within each matrix 201 in each logic block 102 can be individually selectable for stressing and testing purposes. That is, each test device 201 can be individually activated for stressing (i.e., for application of a specific voltage and/or a specific temperature for a predetermined period of time and/or in a predetermined pattern) and for testing (i.e., for determining the impact of applied stress conditions on the electrical characteristics of the test device) by means of one or more multiplexors 204 that provide for matrix column and row selection.

Referring to FIG. 1 in combination with FIG. 2, the test circuit 101 can further comprise a sensor system 103 and an embedded processor 110 (i.e., a on-chip microprocessor or embedded quality monitor (eQM)) operatively connected to the logic blocks 102, to the sensor system 103 and to voltage and temperature regulation systems 111-112 for the chip 100. The embedded processor 110 can control selective stressing of the test devices 202. Specifically, the embedded processor 110 can cause a specific test device 202 in the matrix 201 of a specific logic block 102 to be subjected to specific stress conditions (e.g., a specific voltage and/or a specific temperature over a predetermined period of time and/or in a predetermined pattern). To accomplish this, the embedded processor 110 can control (i.e., can be adapted to control, configured to control, programmed to control, etc.) the voltage and temperature regulation systems 111-112 for the chip 100 to ensure that the specific stress conditions are applied to the specific test device 202.

Those skilled in the art will recognize that the specific stress conditions applied to specific test device will vary depending upon the class of device under test as well as the failure mechanism at issue. For example, for MOSFET-class test devices, stressing to evaluate for gate oxide integrity (GOI) can include stressing at multiple temperatures and voltages for varying timer periods; stressing to evaluate negative bias temperature instability (NBTI) or positive bias temperature instability (PBTI) can include stressing at a stress temperature ranging between −40° C. and 140° C. (preferably 125° C.) and at multiple voltages for varying time periods; stressing to evaluate for hot carrier injection (HCI) can include stressing at a stress temperature ranging between −40° C. and 140° C. (preferably 30° C.) and at multiple gate/drain voltage combinations for varying time periods; and stressing to evaluate BJT-class test devices for reverse bias secondary breakdown (RBSB) can comprise stressing at a constant voltage at a high temperature (preferably 140° C.) for varying time periods.

The embedded processor 110 can also control selective testing of the test devices 202 to determine the impact of the applied stress conditions. That is, the embedded processor 110 can cause (i.e., can be adapted to cause, configured to cause, programmed to cause, etc.) the sensor system 103 to determine an actual value of a specific electrical characteristic exhibited by the specific test device 202 during testing following application of the specific stress conditions. To accomplish this, the multiple logic blocks 102 can each be connected to a corresponding data-in register 104 (i.e., inbound wear-out isolation register (WIR)) and a corresponding data-out register 105 (i.e., an outbound WIR). The embedded processor 110 can first cause data-in 106 to be received by a specific logic block 102 containing the specific test device 202. That is, the embedded processor 110 can transmit a first enable signal 108 to the corresponding data-in register 104 of the specific logic block 102 so that the data-in 106 is released to that specific logic block 102 for processing. The embedded processor 110 can then cause, via multiplexor 204, the data-in 106 to be processed by the specific test device 202. During processing of the data-in 106, the embedded processor 110 can also cause the sensor system 103 to take any measurements required to determine the actual value of the specific electrical characteristic(s) at issue. Then, upon completion of processing, the embedded processor 110 can transmit a second enable signal 109 to the corresponding data-out register 105 of the given logic block 102 so that data-out 107 is released, e.g., for storing in an on-chip data storage 115, for additional processing by the embedded processor 110, etc.

It should be noted that the specific electrical characteristic(s), for which the actual value is determined by the sensor system 103, will vary depending upon the specific class of device under test as well as the specific failure mechanism under test. That is, the sensor system 103 can have the ability to determine (i.e., can be adapted to determine, configured to determine, programmed to determine, etc.) different electrical characteristics associated with the test devices 202 in the logic blocks 102, as directed by the embedded processor 110 and depending upon the specific class of device under test as well as the specific failure mechanism under test. Additionally, since each matrix 201 is configured so that the test devices 202 contained therein are individually selectable for stressing and for testing purposes, the sensor system 103 can determine (i.e., can be adapted to determine, configured to determine, etc.) an electrical characteristic at issue for one or more test devices in one or more of the matrices at a time, while other test devices in the same or different matrices are being subjected to stress conditions.

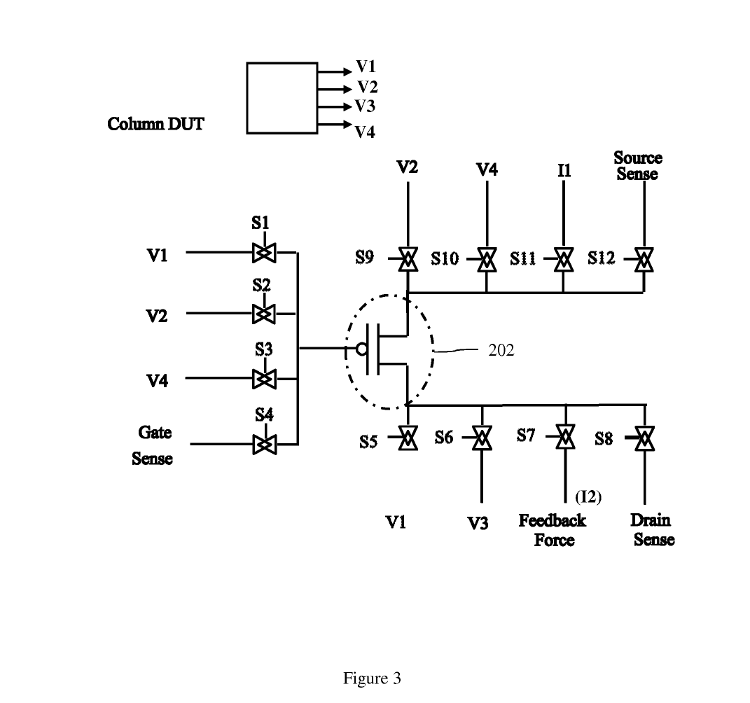

For example, the embedded processor 110 can initiate testing of a specific MOSFET-class test device 202 in a matrix 201 of a specific logic block 102 to evaluate that specific test device for negative bias temperature instability (NBTI), positive bias temperature instability (PBTI), and/or hot carrier injection (HCI) by causing (i.e., directing) the sensor system 103 to determine a drain current (Id)-gate voltage (Vg) value for that test device. The embedded processor 110 can also test that specific MOSFET-class test device to evaluate for gate oxide integrity (GOI) by causing (i.e., directing) the sensor system 103 to determine a gate current (Ig) value. It should be noted that other electrical characteristics, which can be used to evaluate for specific failure mechanisms and which can be determined by the sensor system 103 for such MOSFET-class test devices, can include, but are not limited to, saturated threshold voltage (Vtsat), linear threshold voltage (Vtlin), off current (Ioff), saturated drain current (Idsat), linear drain current (Idlin), etc. FIG. 3 illustrates an exemplary MOSFET-class test device 202 that is configured to allow different voltages to be selectively applied via one or more multiplexors 204 and at least one bus 203 (as shown in FIG. 2) and that is further configured to allow different device parameters to be selectively measured. Specifically, the PMOS device under test (DUT) 202 can have various voltages V1, V2, V3, etc. applied to the various connection points to allow for stressing, testing, etc. by the multiplexors 204 and the bus 203. The voltages V1, V2, V3, etc. applied to the particular DUT 202 in the matrix 201 are independent of other voltages V1, V2, V3, etc. which are applied to the other devices in the matrix. The configuration and selection of each DUT in the matrix 201 is controlled by the signals S1, S2, . . . S12. Thus, the MOSFET-class test device 202 shown in FIG. 3 can be selected for testing by the sensor system 103, as shown in FIG. 1, while other similarly configured MOSFET-class test devices in the same matrix are selected for stressing and vice versa.

The embedded processor 110 can similarly initiate testing (i.e., measuring) of other classes of devices in other logic blocks for associated failure mechanisms. For example, the embedded processor 110 can initiate testing of a bipolar junction transistor (BJT)-class test device for reverse bias secondary breakdown (RBSB) by causing (i.e., directing) the sensor system 103 to determine a collector-base current (Icb) value, an emitter-base current (leb) value, etc. for that BJT-class test device.

The various electrical characteristics at issue can be determined by the sensor system 103 either directly (i.e., by taking a direct measurement) or indirectly (i.e., by measuring one or more device parameters and extracting the electrical characteristic based on the measurement(s) taken), if necessary. Sensor systems that determine the electrical characteristics, directly or indirectly, of different classes of devices under test are well-known in the art and, thus, are omitted from this specification in order to allow the reader to focus on the salient aspect of the disclosed embodiments.

It should be noted that the bus 203, multiplexor 204 and driving circuits, described above and illustrated in FIG. 2, should be designed so as to be able to supply high voltages and currents, as defined by the technology node at issue, without failing during stressing and/or testing. Additionally, it should be noted that depending upon the environment in which the test circuit is used (i.e., laboratory, test system or field), the voltage regulation system 111 employed to apply the specific voltages to the devices under test as well the temperature regulation system 112 employed to apply specific temperatures to the devices under test will vary (see detailed discussions below).

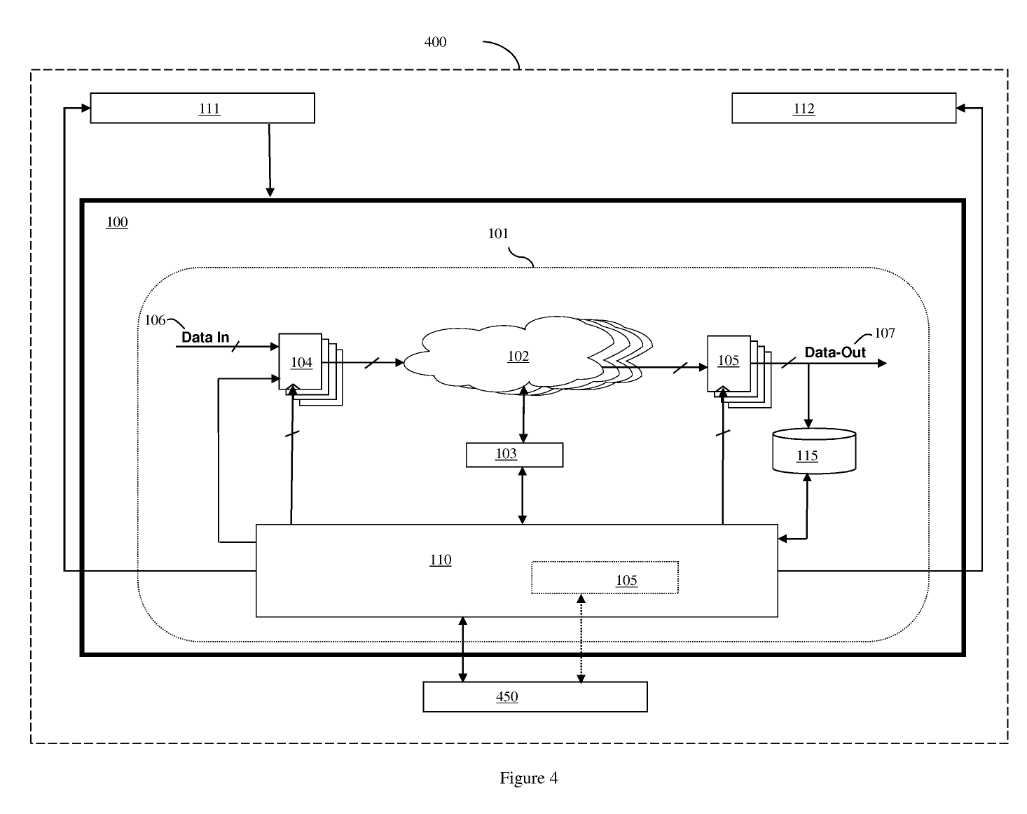

More specifically, referring to FIG. 4 in combination with FIGS. 1-2, one embodiment of an integrated circuit chip 100 can comprise a test circuit 101 designed for use in a laboratory environment. In this case, the test devices 202 in the various logic blocks 102 of the test circuit 101 can comprise duplicates of devices in either a given functional circuit design (e.g., all devices in target circuit design) or a given semiconductor technology node (e.g., all possible devices in a given semiconductor technology node). For purposes of this disclosure, the term “duplicate” refers to an essentially identical copy of a device in terms of device class and physical structure (i.e., component dimensions, geometries, materials, dopants, dopant concentrations, etc.).

The specific stress conditions selectively applied to a test device 202 can comprise, for example, accelerated stress conditions. Such accelerated stress conditions can be applied for a predetermined period of time and/or in a predetermined pattern and can comprise a specific voltage that is higher than the target operational voltage of the device and/or a specific temperature that is higher than target operational temperature. In the laboratory environment, the voltage regulation system 111 for the chip 100 can comprise a discrete voltage regulator (e.g., a stand-alone voltage regulator within the laboratory), which is electrically connected to the logic blocks 102 and the test devices 202 contained therein via at least one bus 203. The embedded processor 110 can cause (i.e., can be adapted to cause, configured to cause, programmed to cause, etc.) this voltage regulator 111 to selectively apply a specific voltage (e.g. via the bus 203) to a specific one of the logic blocks 102 and, more particularly, to at least one specific test device 202 in the specific logic block 102 (e.g., by means of a multiplexor 204) for a predetermined period of time and/or in a predetermined pattern. Additionally, the temperature regulation system 112 for the chip 100 can comprise a discrete heat source (i.e., a standalone heat source) positioned adjacent to the integrated circuit chip 100. This heat source 112 can comprise, for example, an oven that contains and globally heats the integrated circuit chip 100. Alternatively, this heat source 112 can comprise a heating unit that applies directed heat to specific regions of the integrated circuit chip 100. In either case, the embedded processor 110 can cause (i.e., can be adapted to cause, configured to cause, programmed to cause, etc.) the heat source 112 to heat a specific logic block 102 and, more particularly, a specific test device 202 contained therein to a specific temperature for a predetermined period of time and/or in a predetermined pattern.

The embedded processor 110 can further control selective testing of the test devices 202 to determine the impact of the selectively applied stress conditions to one or more electrical characteristics of the specific test device 202. This can be accomplished, as discussed in detail above, by causing data-in 106 to be received by the specific logic block 102 containing the specific test device 202, by causing that specific test device 202 to process the data-in 106, and by causing the sensor system 103 to determine the actual value(s) for the specific electrical characteristic(s) at issue during processing of the data-in. The testing results (i.e., the results of accelerated stress testing) can then be used to model device performance degradation due to various class-specific failure mechanisms and, ultimately, to make device lifetime predictions. That is, the testing results can be used to model performance degradation of the various devices that are contained in either the given functional circuit design (i.e., the target circuit design) or in the given semiconductor technology node and also to make useful life predictions.

The embedded processor 110 can further be in communication with a controller 450 (i.e., a control unit or testing unit). This controller 450 can (i.e., can be adapted to, configured to, programmed to, etc.) install and update, as necessary, the embedded processor programming for selective stressing and testing (i.e., the software or computer program instructions to be executed by the embedded processor in order to perform selective stressing and testing of the test devices), initiate on-demand stressing and/or testing, access testing results for further processing (e.g., to generate and update, as necessary, device performance degradation models), decide to terminate and/or modify stressing/test conditions based on testing results, etc. In the laboratory environment, the embedded processor 110 can be directly wired to the controller 450. Alternatively, the embedded processor 110 can be remote access service (RAS) enabled so as to allow remote communication between the controller 450 and the embedded processor 110. That is, the embedded processor 110 can be configured with the required framework and interface 105 to allow for remote communication therewith. RAS enabled embedded processors are well-known in the art and, thus, the details of the framework and interface required is omitted from this specification in order to allow the reader to focus on the salient aspects of the disclosed embodiments.

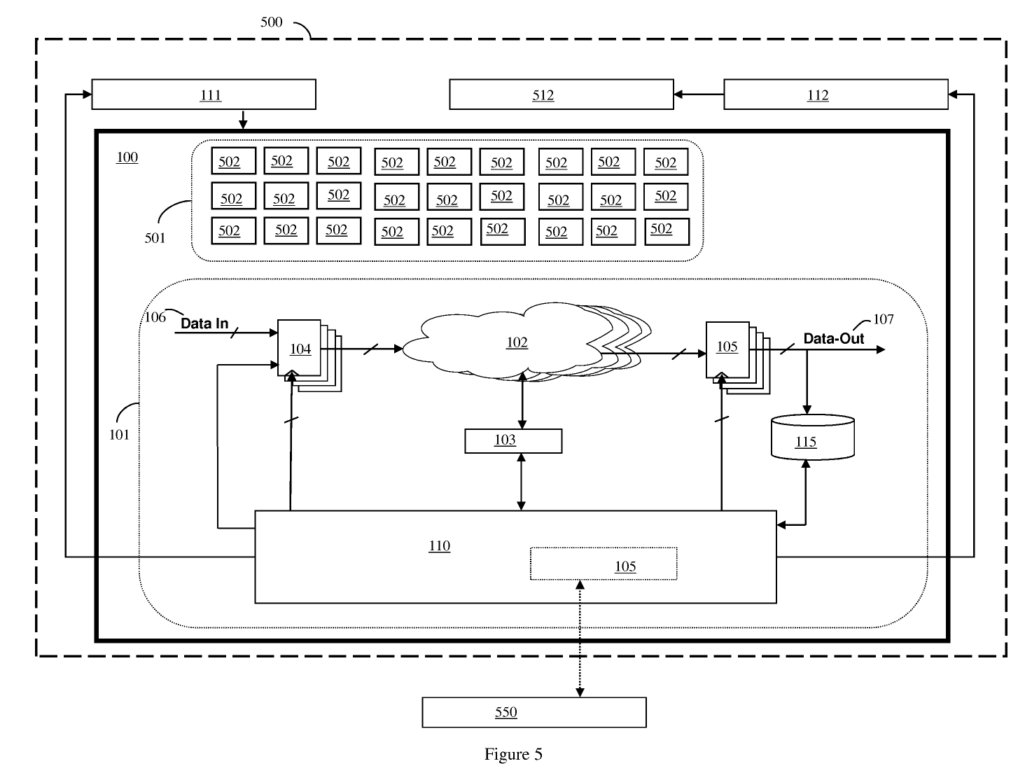

Referring to FIG. 5 in combination with FIGS. 1-2, another embodiment of an integrated circuit chip 100 can comprise a test circuit 101 designed for use in test system environment. Specifically, the integrated circuit chip 100 can be incorporated into a test system 500 and can comprise at least one functional circuit 501 (i.e., a circuit required for operation of the test system 500) in addition to the test circuit 101. The functional circuit(s) 501 can comprise a plurality of active devices 502. These active devices 502 can belong to a variety of different classes of devices (e.g., metal oxide semiconductor field effect transistors (MOSFETs), junction field effect transistors (JFETs), bipolar junction transistors (BJTs), heterojunction bipolar transistors (HBJTs), etc.). Furthermore, the active devices 502 in a given class can have physical differences (e.g., differences in dimensions, geometries, materials, dopants, dopant concentrations, etc.). In this case, the test devices 202 within the logic blocks 102 of the test circuit 101 can comprise duplicates of the active devices 502 in the functional circuit(s) 501. Specifically, each test device 202 in the test circuit 101 can be a duplicate of an active device 502 in a functional circuit(s) 501 such that all active devices 502 that are in the same class of devices and that have the same physical structure are represented by at least one test device 202 in the test circuit 101. As mentioned above, for purposes of this disclosure, the term “duplicate” refers to an essentially identical copy of a device in terms of device class and physical structure (i.e., component dimensions, geometries, materials, dopants, dopant concentrations, etc.).

As in the laboratory environment, the specific stress conditions selectively applied to a test device 202 can comprise, for example, accelerated stress conditions. Such accelerated stress conditions can be applied for a predetermined period of time and/or in a predetermined stressing pattern and can comprise a specific voltage that is higher than the target operational voltage of the device and/or a specific temperature that is higher than target operational temperature. However, since the integrated circuit chip 100 is incorporated into a test system 500, the voltage regulation system 111 for the chip 100 can comprise the voltage regulation system for the entire test system 500. This voltage regulation system 111 can be electrically connected to the logic blocks 102 on the integrated circuit chip 100 and the test devices 202 contained therein via at least one bus 203. The embedded processor 110 can cause (i.e., can be adapted to cause, configured to cause, programmed to cause, etc.) this voltage regulation system 111 to selectively apply a specific voltage (e.g. via the bus 203) to a specific logic block 102 and, more particularly, to a specific test device 202 in that specific logic block 102 (e.g., by means of a multiplexor 204) for a predetermined period of time and/or in a predetermined stressing pattern. Additionally, the temperature regulation system 112 for the chip 100 can comprise a processing control system for one or more additional processors within the test system 500. The embedded processor 110 can regulate the amount of processing performed by the additional processor(s), via the processing control system 512, so as to heat a specific logic block 102 and, more particularly, a specific test device 202 contained therein to a specific temperature for a predetermined period of time and/or in a predetermined pattern. Techniques for using processing control systems to regulate chip temperature are well-known in the art and, thus, the details of such techniques are omitted from this specification in order to allow the reader to focus on the salient aspects of the disclosed embodiments.

The embedded processor 110 can further control selective testing of the test devices 202 to determine the impact of the selectively applied stress conditions to one or more electrical characteristics of the specific test device 202. This can be accomplished, as discussed in detail above, by causing data-in 106 to be received by the specific logic block 102 containing the specific test device 202, by causing the specific test device 202 to process the data-in 106, and by causing the sensor system 103 to determine the actual value(s) for the specific electrical characteristic(s) at issue during processing of the data-in. The testing results (i.e., the results of accelerated stress testing) can then be used to model device performance degradation due to various class-specific failure mechanisms and, ultimately, to make device lifetime predictions. That is, the testing results can be used to model performance degradation of the various devices that are contained in the functional circuit(s) 501 and to make useful life predictions.

As in the laboratory environment, the embedded processor 110 can further be in communication with a controller 550 (i.e., a control unit or testing unit). This controller 550 can (i.e., can be adapted to, configured to, programmed to, etc.) install and update, as necessary, the embedded processor programming for selective stressing and testing (i.e., the software or computer program instructions to be executed by the embedded processor in order to perform selective stressing and testing of the test devices), initiate on-demand stressing and/or testing, access testing results for further processing (e.g., to generate and update, as necessary, device performance degradation models), decide to terminate and/or modify stressing/test conditions based on testing results, etc. However, since the integrated circuit chip 100 is incorporated into a test system 500, this embodiment is only made practicable if the embedded processor 110 is remote access service (RAS) enabled so as to allow remote communication between the controller 550 and the embedded processor 110. That is, in this embodiment, the embedded processor 110 must be configured with the required framework and interface 105 to allow for remote communication therewith. As mentioned above, RAS enabled embedded processors are well-known in the art and, thus, the details of the framework and interface required is omitted from this specification in order to allow the reader to focus on the salient aspects of the disclosed embodiments.

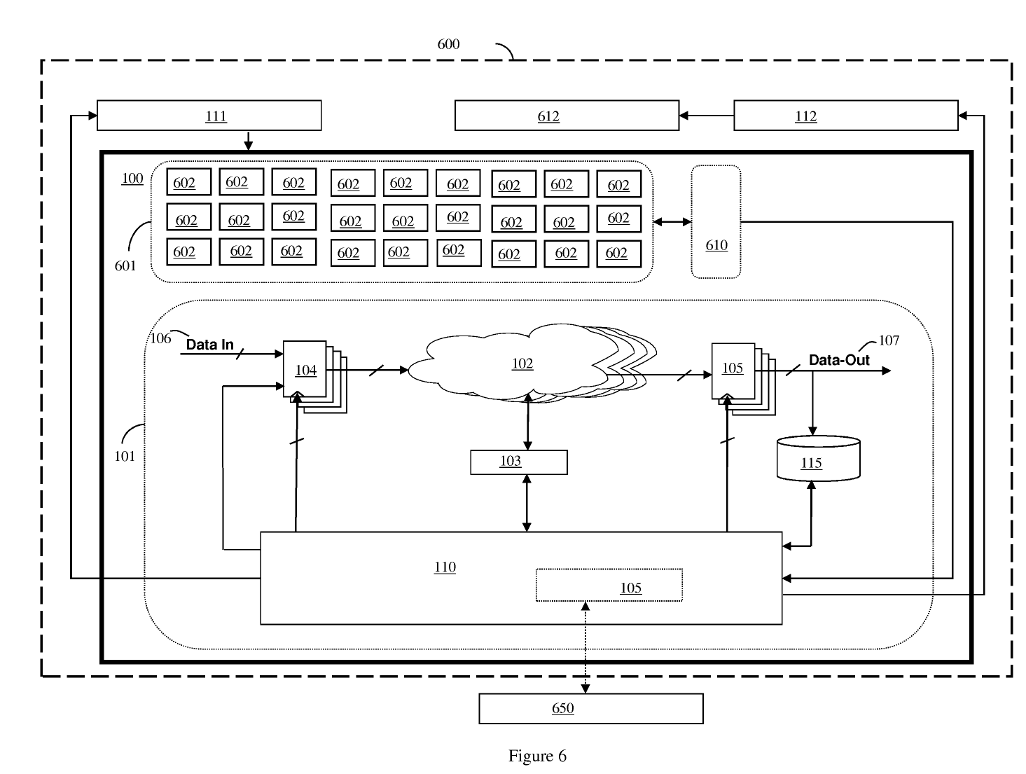

Referring to FIG. 6 in combination with FIGS. 1-2, yet another embodiment of the integrated circuit chip 100 can comprise a test circuit designed for use in the field. Specifically, the integrated circuit chip 100 can be incorporated into (i.e., in use in) a product 600 and can comprise at least one functional circuit 601 (i.e., a circuit required for operation of the product 600) in addition to the test circuit 101. The functional circuit(s) 601 can comprise a plurality of active devices 602. These active devices 602 can belong to a variety of different classes of devices (e.g., metal oxide semiconductor field effect transistors (MOSFETs), junction field effect transistors (JFETs), bipolar junction transistors (BJTs), heterojunction bipolar transistors (HBJTs), etc.). Furthermore, the active devices 602 in a given class can have physical differences (e.g., differences in dimensions, geometries, materials, dopants, dopant concentrations, etc.). In this case, the test devices 202 within the logic blocks 102 of the test circuit 101 can comprise duplicates of the active devices 602 in the functional circuit(s) 601. Specifically, each test device 202 in the test circuit 101 can be a duplicate of an active device 602 in a functional circuit(s) 601 such that all active devices 602 that are in the same class of devices and that have the same physical structure are represented by at least one test device 202 in the test circuit 101. As mentioned above, for purposes of this disclosure, the term “duplicate” refers to an essentially identical copy of a device in terms of device class and physical structure (i.e., component dimensions, geometries, materials, dopants, dopant concentrations, etc.).

In this case, during selective stressing, the specific stress conditions (i.e., specific voltage and/or temperature conditions) applied to a specific test device 202 can approximate (the in-use stress conditions imparted on a corresponding active device. That is, the specific stress conditions applied to the specific test device 202 can be essentially the same as or mimic the stress conditions imparted on an active device 602, which is in use in the product 600 and for which the specific test device is a duplicate. To accomplish this, the integrated circuit chip 100 can further comprise a monitoring system 610 that monitors (i.e., is adapted to monitor, configured to monitor, etc.) the use conditions (e.g., operating times, temperatures, voltages, etc.) of the active devices 602. Systems that monitor use conditions of devices are well-known in the art and, thus, the details of such systems are omitted from this specification in order to allow the reader to focus on the salient aspects of the disclosed embodiments. The monitoring system 610 can further communicate (i.e., be adapted to communicate, configured to communicate, etc.) the determined use conditions to the embedded processor 110 and the embedded processor 110 can subject (i.e., can be adapted to subject, configured to subject, programmed to subject, etc.) the test devices 202 to essentially the same conditions as their corresponding active devices 602 in functional circuit(s) 601. Thus, performance degradation of the test devices 202 due to various class-specific failure mechanisms will be indicative of performance degradation of the corresponding active devices 602 due to the same failure mechanisms.

Since the integrated circuit chip 100 is incorporated into a product 600, the voltage regulation system 111 can comprise the voltage regulation system for that product 600. This voltage regulation system 111 can be electrically connected to the logic blocks 102 on the integrated circuit chip 100 and the test devices 202 contained therein via at least one bus 203. The embedded processor 110 can cause (i.e., can be adapted to cause, configured to cause, programmed to cause, etc.) this voltage regulation system to selectively apply a specific voltage (e.g. via the bus 203) to a specific logic block 102 and, more particularly, to a specific test device 202 in that specific logic block 102 (e.g., by means of a multiplexor 204) for a predetermined period of time and/or in a predetermined pattern. Additionally, the temperature regulation system 112 for the chip 100 can comprise a processing control system 612 for one or more additional processors within the product 600. The embedded processor 110 can regulate the amount of processing performed by the additional processor(s), via the processing control system 612, so as to heat a specific logic block 102 and, more particularly, a specific test device 202 contained therein to a specific temperature for a predetermined period of time and/or in a predetermined pattern. As mentioned above, techniques for using processing control systems to regulate chip temperature are well-known in the art and, thus, the details of such techniques are omitted from this specification in order to allow the reader to focus on the salient aspects of the disclosed embodiments.

As in previously described embodiments, the embedded processor 110 can further control selective testing of the test devices 202 to determine the impact of the selectively applied stress conditions to one or more electrical characteristics of the specific test device 202. This can be accomplished, as discussed in detail above, by causing data-in 106 to be received by the specific logic block 102 containing the specific test device 202, by causing the specific test device 202 to process the data-in 106, and by causing the sensor system 103 to determine the actual value(s) for the specific electrical characteristic(s) at issue during processing of the data-in. Since, as mentioned above, the test devices 202 are subjected to essentially the same use conditions as the active devices 602 in the functional circuit(s) 601, performance degradation of the test devices 202 due to various class-specific failure mechanisms will be indicative of performance degradation of the active devices 602 due to the same failure mechanisms.

As in the laboratory and test system environments, the embedded processor 110 can further be in communication with a controller 650 (i.e., a control unit or testing unit). This controller 650 can (i.e., can be adapted to, configured to, programmed to, etc.) install and update, as necessary, the embedded processor programming for selective stressing and testing (i.e., the software or computer program instructions to be executed by the embedded processor in order to perform selective stressing and testing of the test devices), initiate on-demand stressing and/or testing, access testing results for further processing (e.g., to generate and update, as necessary, device performance degradation models), decide to terminate and/or modify stressing/test conditions based on testing results, etc. However, since the integrated circuit chip 100 is incorporated into a product 600, this embodiment is only made practicable if the embedded processor 110 is remote access service (RAS) enabled so as to allow remote communication between the controller 550 and the embedded processor 110. That is, in this embodiment, the embedded processor 110 must be configured with the required framework and interface 105 to allow for remote communication therewith. As mentioned above, RAS enabled embedded processors are well-known in the art and, thus, the details of the framework and interface required is omitted from this specification in order to allow the reader to focus on the salient aspects of the disclosed embodiments.

It should be noted that the results of in the field stress testing can be used not to generate initial performance degradation models, but rather to diagnose active device failures, to monitor (i.e., track) performance degradation of the active devices in use over time and to update previously generated performance degradation models and useful life predictions. Specifically, the embedded processor 110 or, alternatively, the controller 450 can compare (i.e., be adapted to compare, configured to compare, programmed to compare, etc.) the actual value for a specific electrical characteristic, as determined by the sensor system 103, with a threshold value for that specific electrical characteristic to determine whether or not the device has failed and/or estimate how close to failure the device may be based on existing models and threshold values. The embedded processor 110 or, alternatively, the controller 650 can also compare (i.e., be adapted to compare, configured to compare, programmed to compare, etc.) the actual value for the specific electrical characteristic, as determined by the sensor system 103, with a predicted value for that specific electrical characteristic as indicated by a previously generated performance degradation model for the device. Then, based on the determined difference between the actual and predicted values, the embedded processor 110 or controller 650 can update the performance degradation model for the device and the predicted useful life. Furthermore, repeating the stressing and testing processes allows a user to monitor (i.e., track) the rate of performance degradation of the active devices over time for comparison with the model.

It should be understood that the embodiments as described above are used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

It should further be understood that the terminology used herein is for the purpose of describing particular embodiments only and is not intended to be limiting. As used herein, the singular forms “a”, “an” and “the” are intended to include the plural forms as well, unless the context clearly indicates otherwise. It should further be understood that the terms “comprises” “comprising”, “includes” and/or “including”, as used in this specification, specify the presence of stated features, integers, steps, operations, elements, and/or components, but do not preclude the presence or addition of one or more other features, integers, steps, operations, elements, components, and/or groups thereof. Additionally, it should be understood that the corresponding structures, materials, acts, and equivalents of all means or step plus function elements in the claims below are intended to include any structure, material, or act for performing the function in combination with other claimed elements as specifically claimed. The description of the disclosed embodiments has been presented for purposes of illustration and description, but is not intended to be exhaustive or limiting in the form disclosed. Many modifications and variations will be apparent to those of ordinary skill in the art without departing from the scope and spirit of the disclosed embodiments.

Therefore, disclosed above are embodiments of an integrated circuit chip that incorporates a test circuit having multiple logic blocks. Each logic block is a matrix of individually selectable, physically different, test devices in a specific class of devices. An embedded processor is operatively connected to the logic blocks, a sensor system, and temperature and voltage regulation systems for the chip. The embedded processor ensures that specific stress conditions are selectively applied, by the temperature and voltage regulation systems, to the test devices and further controls selective testing, by the sensor system, of the test devices to determine the impact of the applied stress conditions. In a laboratory or test system environment, accelerated stress conditions are selectively applied to the test devices and the testing results are used to model device performance degradation due to class-specific failure mechanisms. Such a test circuit reduces the number of experiments required for target design qualification (i.e., for validating, debugging and testing designs) and, thereby reduces the time and costs associated with such qualification. In the field (i.e., when incorporate into a product), stress conditions are selectively applied to the test devices so as to mimic the stress conditions impacting active devices in use on the same chip and the testing results are used to indirectly monitor (i.e., indirectly track) performance degradation of the active devices due to class-specific failure mechanisms over time. Such a test circuit allows pro-active measures to be taken in order to meet a client needs.

What is claimed is:

1. An integrated circuit chip circuit comprising:
multiple logic blocks, each one of said multiple logic blocks being associated with a specific class of devices and comprising a matrix of individually selectable, physically different, test devices in said specific class;
a sensor system; and
an embedded processor operatively connected to said multiple logic blocks and said sensor system, said embedded processor controlling selective stressing of said test devices by causing a specific test device to be subjected to specific stress conditions and further controlling selective testing of said test devices by causing said sensor system to determine an actual value of a specific electrical characteristic exhibited by said specific test device following application of said specific stress conditions.

2. The integrated circuit chip of claim 1, said sensor system determining different electrical characteristics depending upon said specific class and a specific failure mechanism associated with said specific class.

3. The integrated circuit chip of claim 1,
said test devices being duplicates of active devices in any one of the following: a given functional circuit design; and a given semiconductor technology node, and
said testing being performed in order to generate performance degradation models for said active devices.

4. The integrated circuit chip of claim 1, said specific stress conditions comprising a specific voltage and said embedded processor being operatively connected to a voltage regulator and causing said voltage regulator to apply said specific voltage to said test device.

5. The integrated circuit chip of claim 1, said specific stress conditions comprising a specific temperature and said embedded processor being operatively connected to a heat source and causing said heat source to heat said test device to said specific temperature.

6. The integrated circuit chip of claim 1, said embedded processor being in communication with a controller, said controller at least updating embedded processor programming and receiving results of said testing from said embedded processor.

7. The integrated circuit chip of claim 6, said embedded processor further being remote access service (RAS) enabled so as to allow for remote communication between said controller and said embedded processor.

8. The integrated circuit chip of claim 1, said multiple logic blocks each being connected to a corresponding data-in register and a corresponding data-out register, said embedded processor further controlling said testing by transmitting a first enable signal to said corresponding data-in register of a specific logic block containing said specific test device so that data-in is released to said given logic block, causing said specific test device to process said data-in, causing said sensor system to determine said actual value of said specific electrical characteristic and transmitting a second enable signal to said corresponding data-out register of said specific logic block when processing of said data-in by said specific test device is complete so that data-out is released.

9. An integrated circuit chip incorporated into a test system, said integrated circuit chip comprising:
at least one functional circuit comprising a plurality of active devices; and
a test circuit comprising:
multiple logic blocks, each one of said multiple logic blocks being associated with a specific class of devices and comprising a matrix of individually selectable, physically different, test devices in said specific class, said test devices being duplicates of said active devices;
a sensor system; and
an embedded processor operatively connected to said multiple logic blocks and said sensor system,
said embedded processor controlling selective stressing of said test devices by causing a specific test device to be subjected to specific stress conditions and further controlling selective testing of said specific test device by causing said sensor system to determine an actual value of a specific electrical characteristic exhibited by said specific test device following application of said specific stress conditions, and
said embedded processor further being remote access service (RAS) enabled so as to allow for remote communication with said embedded processor.

10. The integrated circuit chip of claim 9, said sensor system determining different electrical characteristics depending upon said specific class and a specific failure mechanism associated with said specific class.

11. The integrated circuit chip of claim 9, said testing being performed in order to generate performance degradation models for said active devices.

12. The integrated circuit chip of claim 9, said specific stress conditions comprising a specific voltage and said embedded processor being operatively connected to a voltage regulation system for said test system and causing said voltage regulation system to apply said specific voltage to said specific test device.

13. The integrated circuit chip of claim 10, said specific stress conditions comprising a specific temperature and said embedded processor regulating an amount of processing performed by said test system so as to heat said specific test device to said specific temperature.

14. The integrated circuit of claim 10, said multiple logic blocks each being connected to a corresponding data-in register and a corresponding data-out register, said embedded processor further controlling said testing by transmitting a first enable signal to said corresponding data-in register of a specific logic block containing said specific test device so that data-in is released to said given logic block, causing said specific test device to process said data-in, causing said sensor system to determine said actual value of said specific electrical characteristic and transmitting a second enable signal to said corresponding data-out register of said specific logic block when processing of said data-in by said specific test device is complete so that data-out is released.

15. An integrated circuit chip incorporated into a product, said integrated circuit chip comprising:
at least one functional circuit comprising a plurality of active devices in use in said product; and
a test circuit comprising:
multiple logic blocks, each one of said multiple logic blocks being associated with a specific class of devices and comprising a matrix of individually selectable, physically different, test devices in said specific class, said test devices being duplicates of said active devices;
a sensor system; and
an embedded processor operatively connected to said multiple logic blocks and said sensor system,
said embedded processor controlling selective stressing of said test devices by causing a specific test device to be subjected to specific stress conditions and further controlling selective testing of said test devices by causing said sensor system to determine an actual value of a specific electrical characteristic exhibited by said specific test device following application of said specific stress conditions, said specific stress conditions approximating in-use stress conditions imparted on a corresponding active device, and
said embedded processor further being remote access service (RAS) enabled so as to allow for remote communication with said embedded processor.

16. The integrated circuit chip of claim 15, said sensor system determining different electrical characteristics depending upon said specific class and a specific failure mechanism associated with said specific class.

17. The integrated circuit chip of claim 15, said testing being performed in order to monitor said performance degradation of said test devices and, thereby, to monitor said performance degradation of said active devices.

18. The integrated circuit chip of claim 15, said embedded processor further comparing said actual value with a predicted value for said specific electrical characteristic as indicated by a performance degradation model.

19. The integrated circuit chip of claim 18, said embedded processor updating said performance degradation model when said actual value and said predicted value are different.

20. The integrated circuit chip of claim 15, said specific stress conditions comprising a specific voltage and said embedded processor being operatively connected to a voltage regulation system for said product and causing said voltage regulation system to apply said specific voltage to said specific test device.
